(19) United States
(12) Patent Application Publication
(10) Pub. No.: US 2004/0139463 A1
(43) Pub. Date: Jul. 15, 2004

(54) Data broadcasting receiving and reproducing apparatus

(75) Inventors: Shuntaro Aratani, Tokyo (JP); Katsuhiro Miyamoto, Kanagawa (JP); Tomoyuki Ohno, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/724,700

(22) Filed: Dec. 2, 2003

(30) Foreign Application Priority Data
Dec. 11, 2002 (JP) 2002-359517

(51) Int. Cl. H04L 12/28; H04L 12/56

(52) U.S. Cl. 725/37

(57) ABSTRACT

To enable permission or inhibition of printing of data to be controlled, a printability property showing the permission/inhibition of the printing is included in a style attribute of each contents of XML data which is data-broadcasted. By a print instruction, a printability property value of the style attribute of each contents of the received XML data is read out (S6-2). If there is no designation of the printability property and if there is designation of printability=true (S6-2), visualization (rendering) of the contents is executed (S6-5). If printability=false (S6-2), the rendering of the contents is not executed, but a processing of the next contents is executed (S6-3).

### BACKGROUND OF THE INVENTION

1. Field of the Invention

The invention relates to a data broadcasting receiving and reproducing apparatus and, more particularly, to a data broadcasting receiving and reproducing apparatus for receiving data broadcasting contents in which characters, images, audio sound, video images, and the like have been multiplexed and executing a display, reproduction, and printing.

2. Related Background Art

In BS digital broadcasting, data broadcasting has already been started. According to it, a broadcasting station multiplexes data to a broadcasting radio wave and transmits the obtained radio wave. On a receiving apparatus side, the broadcasting radio wave is received and accumulated and the data is displayed on a display screen.

A construction of a television receiver for receiving the BS digital broadcasting will be described. At the broadcasting station, program data and audio data of ordinary television programs and data broadcasting data are encoded. After those encoding signals are multiplexed, they are modulated and outputted from an antenna. The signal outputted from the antenna is transmitted to a terminal (television receiver) of a user side via a broadcasting satellite (BS).

In the television receiver, a tuner extracts a signal of a frequency band of a channel corresponding to a program selected by the user from the received signal. The tuner executes processings such as demodulation, error correction, and the like to the inputted signal, thereby forming digital data in a format called a transport stream (TS). Output data of the tuner is applied to a transport decoder via a descrambler.

The transport decoder extracts a packet corresponding to the program selected by the user. Video data in the extracted packet is decoded by a video decoder and, thereafter, sent to a moving image plane in a graphic buffer. The audio data in the extracted packet is decoded by an audio decoder and, thereafter, outputted to a speaker. The data broadcasting data in the extracted packet is sent to a CPU (Central Processing Unit) and decoded and, thereafter, stored into a data storing device. When contents of the data broadcasting are displayed, the CPU reads out the data stored in the data storing device and converts it into image data of characters and graphics by a graphic generating unit. Thereafter, the converted image data is sent to a character graphic plane or a still image plane of the graphic buffer.

The character graphic plane stores mainly a bit image such as button, text, graphic, picture, or the like serving as a UI (User Interface) in the data broadcasting. The still image plane stores a bit image such as a photograph image or the like.

A screen image synthesizing unit synthesizes the graphic data which is stored in the moving image plane, the character graphic plane, and the still image plane in the graphic buffer and outputs the synthesized data to a display.

The broadcasting station repetitively sends the digital data of the data broadcasting on the basis of a data karrusel system of DSM-CC specified in ISO/IEC13818-6. Text information, script information, image information, and video/audio data are included in the data broadcasting data filtered by the transport decoder. The text information is described by an XML (extensible Markup Language) specified by W3C.

There are independent data broadcasting and program linked data broadcasting in the data broadcasting services. The viewer can easily browse various information by the former data broadcasting. A service to display information linked with a television program by characters and images can be provided by the latter data broadcasting.

At present,.a trial to provide various services to the viewers of general homes by using the data broadcasting is being made. For example, it is considered that if not only the information distributed by the data broadcasting services is displayed on a television display screen but also such information can be easily printed by a printer by using a remote control and kept, a range of services is more widened and, at the same time, use convenience of the user is improved as compared with the present.

For example, an application such that contents with a copyright such as photograph collection, poster, or the like is distributed by the data broadcasting and printed by the TV receiver has also been considered as a service using the data broadcasting. A system for distributing information of a newspaper, a magazine, a poster, and the like and printing it has been disclosed in Japanese Patent Application Laid-Open No. H11-313191. A method of partially printing contents has been disclosed in Japanese Patent Application Laid-Open No. H09-160899.

The conventional broadcasting system and TV receiving apparatus have the following problems in the case of providing the foregoing services to which the data broadcasting has been applied.

As a first problem, if a copyright or a right of portrait exists in video images, images, and character data which are being displayed, when the viewer prints a display image or received information during the monitoring of the program, he needs to obtain permission with respect to those rights.

As a second problem, in the broadcasting system and the TV receiving apparatus which have conventionally been proposed, since there is not a mechanism for charging for a specific portion of printed matter as a target, for example, in the case where photographs of several persons of talent exist in one sheet of printed matter, the operation such that the fee only for the photograph portion of one person of talent is paid and such a photograph portion is printed cannot be executed.

As a third problem, for example, if a child has erroneously printed a large amount of toll contents or free contents during the absence of the contracted user, the contracted user is charged for a burden of a contents fee, costs of print ink and print paper, and the like.

### SUMMARY OF THE INVENTION

It is an object of the invention to provide a receiving apparatus which can receive a print contents distributing service using data broadcasting whose printing can be controlled in detail in a data broadcasting system and a data broadcasting receiving apparatus in which the user who is monitoring a data broadcasting program can easily print information that is being displayed and desired information by a remote control operation.

According to the invention, there is provided a data broadcasting receiving and reproducing apparatus comprising: receiving means for receiving a digital broadcasting wave; data obtaining means for obtaining data broadcasting data constructed by a plurality of contents from the digital broadcasting wave received by the receiving means; display control means for displaying the plurality of contents onto display means on the basis of the data broadcasting data obtained by the data obtaining means; selecting means for selecting specific one of the plurality of contents displayed on the display means on the basis of print permission/inhibition information showing permission or inhibition of printing of each contents; print control means for converting the contents selected by the selecting means into print data and outputting the print data to printing means; and print maintenance means for changing the print permission/inhibition information, wherein the print maintenance means changes the print permission/inhibition information in accordance with command information.

It is desirable that the command information is transmitted together with a broadcasted event included in the digital broadcast wave and the print maintenance means makes control based on the command information in accordance with execution of the broadcasted event.

It is desirable that the data broadcasting data includes charge information set in each of the contents and the display control means sums the charge information of the contents selected by the selecting means and displays the sum.

According to further another aspect of the invention, there is provided a data broadcasting print service system which includes a data broadcasting apparatus for previously adding an attribute to each contents of data comprising a plurality of contents such as video images, audio sound, characters, images, and the like, thereafter, multiplexing the resultant contents to a broadcasting wave, and transmitting the multiplexed contents and in which the broadcasting data is received, stored, reproduced, and displayed by a data broadcasting receiving and reproducing apparatus of the viewer and the data is transferred to a printing apparatus and print-outputted, wherein the data broadcasting receiving and reproducing apparatus further has a function for determining whether the broadcasting data is transferred to the printing apparatus or not in accordance with the attribute added to each contents of the broadcasting data and a broadcasted event extracting function for extracting a broadcasted event included in the broadcasting wave, and print permission/inhibition information of each of the contents is changed in accordance with the broadcasted event.

For example, the broadcasting data is text data which is described by a markup language and includes contents whose print permission/inhibition attribute has been preset.

It is desirable that the broadcasting data includes script information, the data broadcasting receiving and reproducing apparatus has a script executing function, executes a script included in the broadcasting data in accordance with the broadcasted event or the user input information, and changes the print permission/inhibition information of each of the contents.

### BRIEF DESCRIPTION OF THE DRAWINGS

FIG. 1 is a schematic constructional block diagram of a television receiver in the first embodiment of the invention;

FIG. 2 is a plan view of a remote control;

FIG. 3 is a flowchart showing a part of the operation of browser software which is operated by a CPU;

FIG. 4 is comprised of FIGS. 4A and 4B showing diagrams of the XML data;

FIG. 5 is a diagram showing a display example of the XML data;

FIG. 6 is a diagram showing another display example of the XML data;

FIG. 7 is a flowchart showing the operation of a print processing program in the first embodiment;

FIG. 8 is a diagram showing an example of a print output result in the first embodiment;

FIG. 9 is a diagram showing another example of the print output result in the first embodiment; and

FIG. 10 is a diagram showing an example of a display output of XML data and a script in a modification of the first embodiment.

### DETAILED DESCRIPTION OF THE PREFERRED EMBODIMENTS

### First embodiment

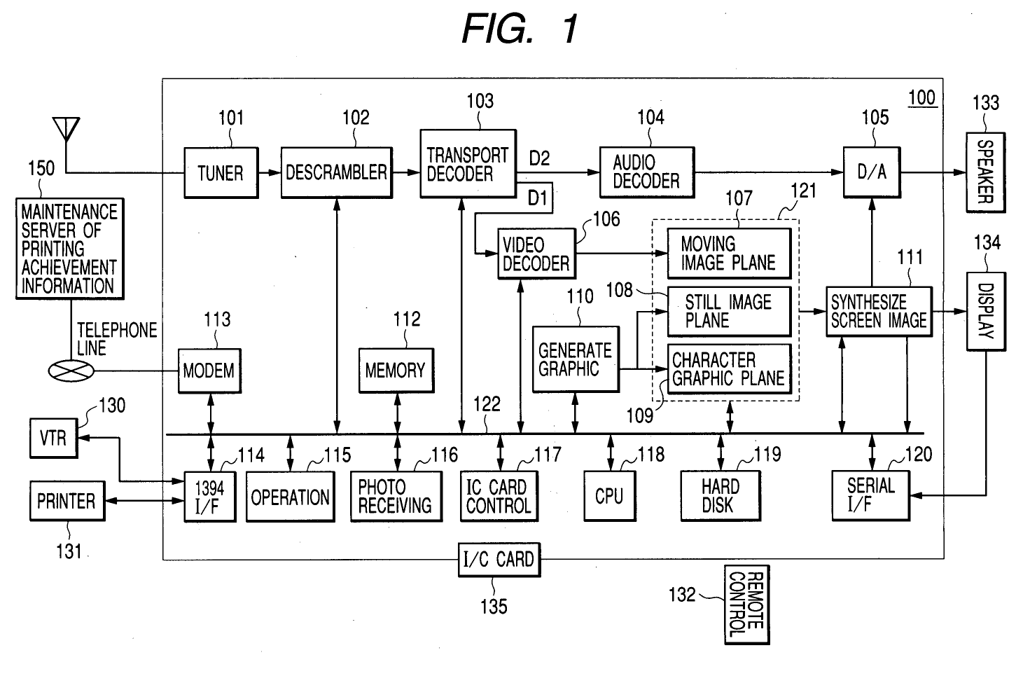

FIG. 1 is a schematic constructional block diagram of a digital television receiving apparatus 100 according to an embodiment of the invention.

A signal received by an antenna (not shown) is inputted to a tuner 101. The tuner 101 executes processings such as demodulation, error correction, and the like to the inputted signal, thereby forming digital data in a format called a transport stream (TS). The data of the transport stream (TS) is inputted to a descrambler 102.

When TS data which has preliminarily been scrambled for the purpose of limiting the monitoring is inputted from the tuner 101, the descrambler 102 cancels the scramble on the basis of key information for descrambling included in the TS data and key information which is outputted from an IC card control unit 117 and outputs the descrambled data to a transport decoder 103.

The IC card control unit 117 includes an IC card in which contract information of the user and key information for decrypting the key information for descrambling included in the TS data have been stored. If the key information for decoding the key information for descrambling which has been inputted from the descrambler 102 exists, the IC card control unit 117 outputs such key information to the descrambler 102.

When TS data which is not scrambled is inputted from the tuner 101, the descrambler 102 outputs the TS data to the transport decoder 103.

The transport decoder 103 extracts a packet corresponding to the program selected by the user. Video data in the extracted packet is decoded by a video decoder 106 and, thereafter, transmitted to a moving image plane 107 in a graphic buffer 121. Audio data in the extracted packet is decoded by an audio decoder 104 and, thereafter, sent to a speaker 133 via a D/A converter 105. Data broadcasting data in the extracted packet is stored into a memory 112 via a bus 122 connected to a CPU 118, decoded by a processing, which will be explained hereinlater, of the CPU 118, and thereafter, stored onto a hard disk 119. When the contents of the data broadcasting are displayed, the CPU 118 reads out the data stored in a data storing device, converts it into image data of characters and graphics by a graphic generating unit 110, and thereafter, sends it to a character graphic plane 109 or a still image plane 108 in the graphic buffer 121.

A screen synthesizing unit (screen blending unit) 111 synthesizes or switches the graphic data stored in the moving image plane 107, character graphic plane 109, and still image plane 108 in the graphic buffer and outputs the resultant data to a display 134. The display 134 displays the transmitted image.

As shown in FIG. 1, each of the blocks is connected to the common bus 122.

An IEEE1394 interface 114 and a modem 113 are further connected to the bus 122. The IEEE1394 I/F 114 is used for the TV receiving apparatus 100 to make protocol communication with a VTR 130 and a printer 131 which are connected to the outside. The modem 113 is used to make information communication with a server computer (maintenance server of printing achievement information) 150 which is operated by the broadcasting enterprise or the like via a telephone line.

The digital data of the data broadcasting is repetitively sent from a broadcasting station by the data karrusel system of DSM-CC specified in ISO/IEC13818-6. The data broadcasting data filtered by the transport decoder 103 includes text information, script information, image information, and video/audio data. The text information has been described by the XML (extensible Markup Language) specified by W3C.

In the embodiment, as a specification of the XML for reproducing the data broadcasting, the specification fundamentally based on the XHTML specification in which HTML4.0 has been fixed again by XML1.0 is used. In the XML, an attribute is added (meaning is added) to a character train in a document by a tag (portion surrounded by <xxx> and </xxx>). Such a tag can be inserted in a telescopic manner.

In the embodiment, a CSS (Cascading Style Sheet) is used as a display format and JavaScript (registered trademark) is used as a script processing. A DOM (Document Object Model) is used as a format for accessing the contents data from the script. In the embodiment, a format obtained by expanding DOM Level 1 as W3C Recommendation is used.

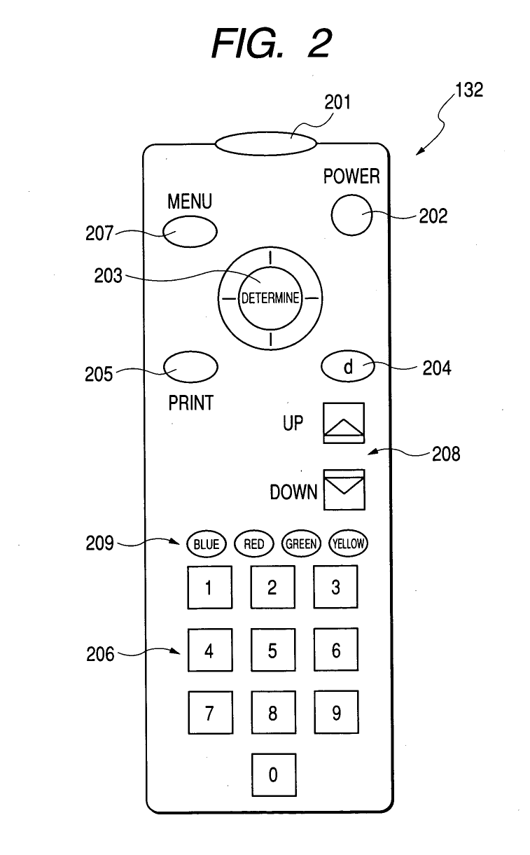

FIG. 2 shows a plan view of a remote control 132. Only operation buttons for realizing functions which are necessary for explaining the embodiment are shown in FIG. 2. A larger number of operation buttons are provided for the actual receiving apparatus.

Reference numeral 201 denotes a light emitting unit for making infrared communication with the remote control 132 and a photo receiving unit 116 (FIG. 1); 202 a power key for instructing on/off of a power source; and 203 a cursor key in a stick shape. By inclining the cursor key 203 to the top/down (front/rear) and right/left, a cursor can be moved in four directions and inputted. By depressing the stick itself, “determine” is inputted.

Reference numeral 204 denotes a “d” key (d-button) to instruct the display of the data broadcasting; 205 a print key to execute a printing processing; 206 a ten-key in which numeral keys are arranged in a matrix form; and 207 a menu button to display a menu display screen.

Reference numeral 208 denotes an up/down key comprising an up key and a down key; and 209 a color key in which buttons of four colors (blue, red, green, and yellow) are arranged in lateral line.

The operation of the digital TV receiving apparatus with the above construction will be described with reference to flowcharts showing a processing procedure which is executed by the CPU 118.

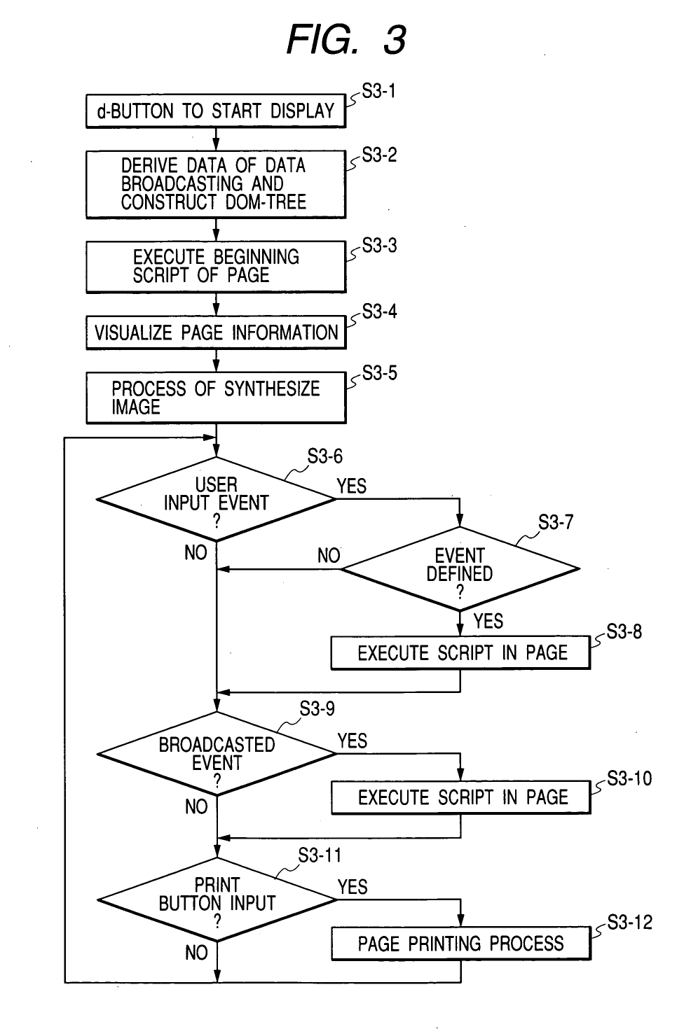

FIG. 3 is an operation flowchart for a data broadcasting receiving and reproducing program which is operated by the CPU 118. This program comprises a data receiving program, a data displaying program, a script executing program, and a data printing program and they are collectively called a “browser”.

When the user presses the d-button 204 of the remote control and instructs the display of the data broadcasting during the monitoring of a television program, the execution of the data broadcasting displaying program of the browser is started (step S3-1).

Subsequently, the transport decoder 103 is controlled, the reception of the data broadcasting contents which is transmitted by the data karrusel system is started, and XML data for displaying a display screen, XML data for printing, and related data such as images, moving images, and the like embedded in those XML data are obtained. A DOM-tree structure is constructed on the basis of the obtained XML data (S3-2).

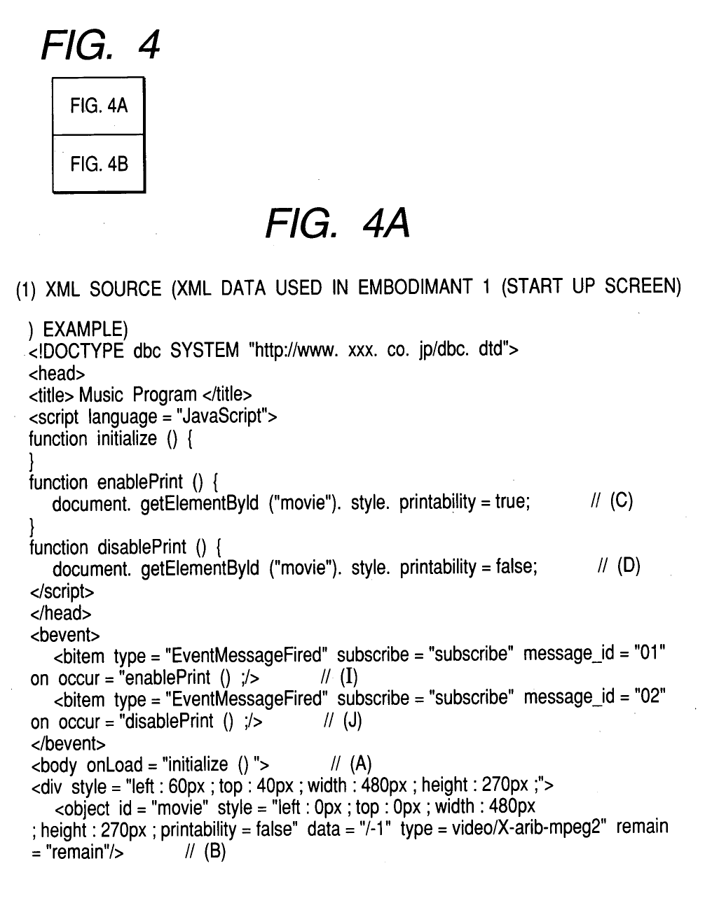

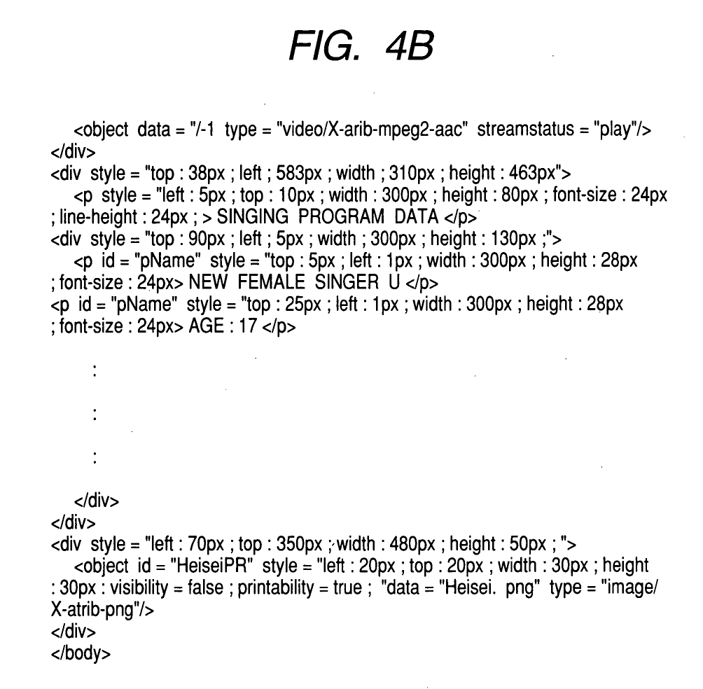

XML data (1) in FIG. 4 shows an example of XML data (startup. xml) for an initial display screen (start up screen) of the data broadcasting program in a singing program. In this example, a Title element showing a name of a sentence and a <script> element showing a definition of a script are included in a portion surrounded by a <head> tag and a </head> tag. An <object> element showing images and video images/audio sound, a <div> element showing an area on the display screen, a <p> element showing the sentence, and the like are included in a <body> element showing a body of the sentence. A style attribute according to the CSS is described in each element (contents) and coordinates, a size, a color, and the like at the time of displaying have been set.

A script function described in an OnLoad attribute ((A) of XML data (1)) of a <body> tag is executed as a beginning script (S3-3). A portion sandwiched by <script> and </script> is a script description. In this example, an initialize function ((B) of XML source (1)) becomes the beginning script. In the example of the description, the beginning script is not executed.

The browser executes a visualizing processing (S3-4) of page information and a moving image synthesizing processing (S3-5) on the basis of the information described in the <body> element of the XML data (1).

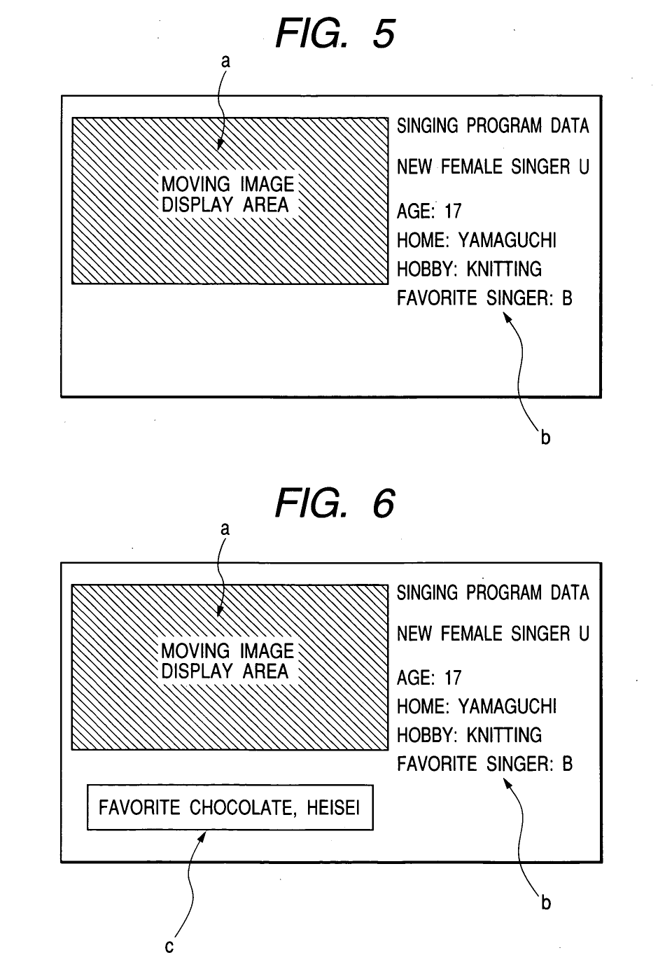

FIG. 5 shows an example of a display screen in the case where the browser displayed the XML data (1). This display screen comprises: a moving image portion (a in the diagram) which displays a program (moving image); and a character portion (b in the diagram) which displays detailed information of the person of talent who is making appearance in the program that is being broadcasted. FIG. 6 shows a display example in which a character train (c in the diagram) “FAVORITE CHOCOLATE, HEISEI” has additionally been displayed by an additional event.

After that, the script is executed in accordance with the generation of events such as user event, broadcasted event, and the like (S3-6, S3-9). When the user presses the print key 205 of the remote control 132, a printing processing of data broadcasting contents which is being displayed is started (S3-11→S3-12).

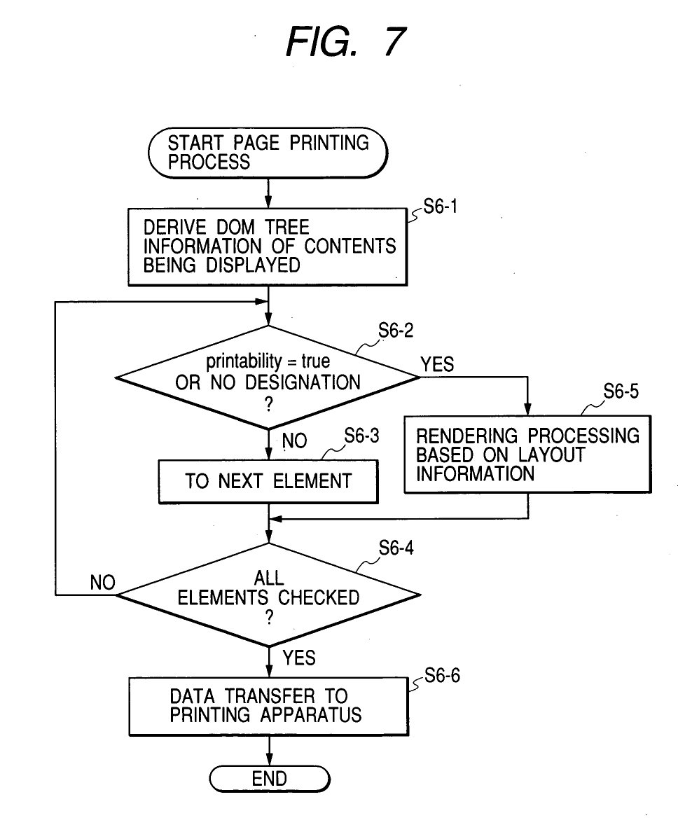

FIG. 7 is a flowchart showing a flow for the printing processing of the data broadcasting contents which is executed by the browser. After that, the operation will be described in order of this processing.

When a page printing processing is started, the browser obtains DOM-tree information of the contents which is being displayed (S6-1). The DOM-tree information is traced from the beginning to the end and a printability property value of a style attribute of each element, that is, print permission/inhibition information showing the permission or inhibition of the printing of each contents is read out. If there is no designation of the printability property and if there is a designation of printability=true (S6-2), the visualization (rendering) of such an element is executed (S6-5). If printability=false, the rendering of such an element is not executed but the processing routine advances to a processing of the next element (S6-3).

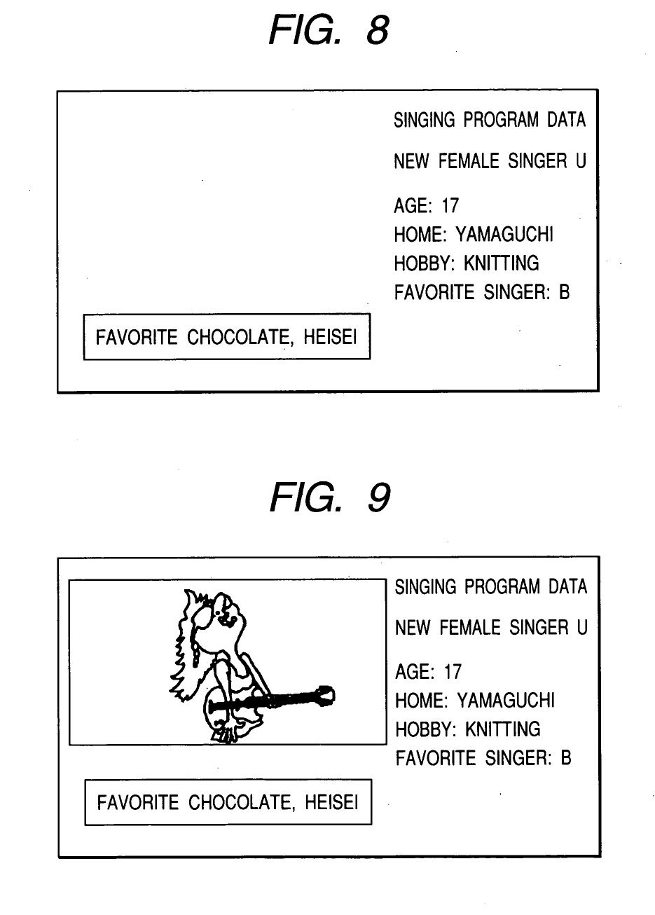

By the above operation, for example, in the case of the contents (DOM-tree information) of the display example shown in FIG. 5, since the printability property of an object element to which an ID “movie” shown in (b) of the XML data (1) in FIG. 4 has been added is false, the visualizing processing of such an element (moving image contents shown in (a) in FIG. 5) is not executed. Since there is no designation of the printability property with respect to other text elements, the visualizing processing of such an element (text contents shown in (b) in FIG. 5) is executed. Since the setting showing that the printability property is true has been made to an object element of the-image to which an ID “HeiseiPR” described in the latter half of the XML data (1) has been added, the visualizing processing of such an element (text contents shown in (c) in FIG. 6) is executed. FIG. 8 shows an example of a print result in such a case. As will be also understood from FIG. 8, the video image portion (contents) is not printed but only other portions (contents) are printed. An image (portion in which “FAVORITE CHOCOLATE, HEISEI” has been written) which does not exist in the display data has been printed.

Subsequently, processings of the browser which are executed in the case where the broadcasted event has been transmitted from the broadcasting station while the same data broadcasting program is being broadcasted will be described. When the broadcasted event is received, the processing in step S3-9 in FIG. 3 is executed and the script corresponding to the event contents is executed. In the example of the XML data (1), a script (enableprint()) (command information) to be executed when the event is generated has been defined in the portion shown in (1). In accordance with it, the browser executes the script enableprint() (S3-10). In the script enableprint(), a processing for changing the value of the printability property of the object element to “true”, that is, a processing for changing print permission/inhibition information in accordance with the command information included in the digital broadcasting wave is executed (refer to (C) of the XML data (1) in FIG. 4).

When the print button of the remote control is again pressed in this state and the page printing processing shown in FIG. 7 is started, since the value of the printability property of the object element to which the ID “movie” has been added has been changed to “true”, the visualizing (rendering) processing is executed in this portion in step S6-5. A still image of one frame of the moving image allocated to the area “a” in FIG. 5 is printed. FIG. 9 shows a print result in this case. The still image as one display screen of the moving image has been printed in the portion corresponding to the moving image display area “a” of the display screen.

As will be understood from the above description, according to the embodiment, since the object (moving image, still image, text, graphic, etc.) which can be printed can be preset from the broadcasting station side, it is possible to control so that the user cannot arbitrarily print the image/video image with the right of portrait or the copyright. Since the permission or inhibition of the printing of the object can be controlled by the broadcasted event, for example, it is also possible to enable the printing only during a commercial. Further, contents which is not displayed in the display contents can be also printed. For example, it is also possible to provide a service such that the printing on the user side is permitted under a condition that a commercial video image or an advertisement of a sponsor is printed together with the display contents.

Although the example in which the printing of the video image and the image (photograph) is permitted or inhibited has been described here, naturally, the invention is not limited to it. For example, the setting of the inhibition of the printing can be made also with respect to sentence information such as novel or news article in which a copyright is caused.

Although the attribute to set the permission or inhibition of the printing has been realized by expanding the property “printability” with respect to the property of the CSS (Cascading Style Sheet) which is often used in the WWW (World Wide Web) in the embodiment, the invention is not limited to it but can be also realized by a method whereby XML elements <printable> and </printable> are formed as print permission/inhibition information and all elements included in them are set to be printable.

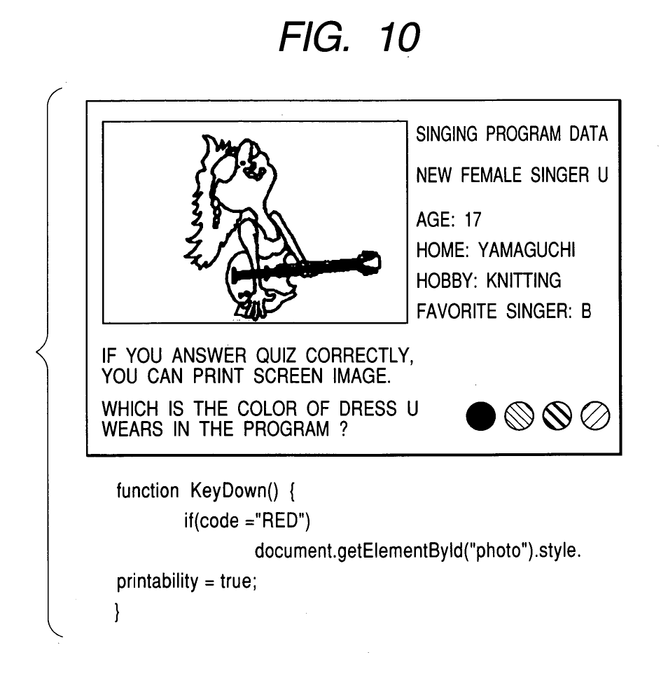

Further, as an event to control the permission or inhibition of the printing, in addition to the broadcasted event, a user input event can also similarly control the permission or inhibition of the printing. For example, it is also possible to realize such control by a method whereby the user answers a quiz displayed as shown in FIG. 10 and presses a remote control button of a correct answer, so that the printing of the display screen which is being displayed is permitted, or the like.

Although the XML and CSS have been used for the contents description, display style description, and print style description of the data broadcasting in the embodiment, the invention is not limited to them from a viewpoint of the spirit of the invention but the HTML or the like can be used. A data information format other than the markup language can be also used. Similarly, although the example according to the specification of JavaScript has been described with respect to the script processing, it is also possible to use a program developed by another script language, a macro language, a Java (registered trademark) language, or the like.

Although the case where the TS (transport stream) which is being broadcasted at present is received and reproduced, displayed, or printed has been described in the embodiment, the invention is not limited to it from the viewpoint of the spirit of the invention but can be applied to a case where the TS is recorded once by a video recording apparatus or a hard disk apparatus and, thereafter, reproduced, displayed, or printed.

As will be easily understood from the above description, according to the embodiment of the invention, since whether the printing is executed or not is determined in accordance with the attribute of each contents included in the received data broadcasting data, the permission or inhibition of the printing can be controlled every attribute. Also in the case where the charge information has been added as an attribute, it is possible to construct the apparatus in a manner such that the printing is not partially executed or the user is allowed to select whether the printing is executed or not. Further, an upper limit of the number of print sheets can be set.

For example, although there is a problem such that if the viewer freely prints information “the user wants to print and keep” while he is monitoring the program, the information is also printed when the copyright or the right of portrait exists in the video image, image, or character data which is being displayed, according to the invention, since the permission or inhibition of the printing can be designated on an element unit basis of XML, such a problem can be prevented. Further, according to the invention, since the information about the permission or inhibition of the printing can be changed from the broadcasted event or the user event, a service such that the printing is permitted only under predetermined conditions can be also realized.

Further, since not only it is possible to charge for a specific portion of the printed matter as a target but also the user side can select and print only a desired portion, a degree of freedom of selection of the user side is fairly widened.

Moreover, for example, even if a child intends to erroneously print a large amount of toll contents or free contents during the absence of the contracted user or the like, since the printing of the number which is equal to or larger than the limited number of sheets which has been preset on the setting display screen is not performed, a risk that the contracted user is charged for the burden of the contents fee, costs of print ink and print paper, and the like can be reduced.

According to the invention, not only the conventional problems can be solved but also the degree of freedom of the print services using the data broadcasting and the width of services can be widened as mentioned above. Maintenance of the broadcasting service system of customer's satisfactory degree higher than the conventional one can be realized.

What is claimed is:

1. A data broadcasting receiving and reproducing apparatus comprising:
receiving means for receiving a digital broadcasting wave;
data obtaining means for obtaining data broadcasting data constructed by a plurality of contents from said digital broadcasting wave received by said receiving means;
display control means for displaying said plurality of contents onto display means on the basis of said data broadcasting data obtained by said data obtaining means;
selecting means for selecting specific one of said plurality of contents displayed on said display means on the basis of print permission/inhibition information showing permission or inhibition of printing of each contents;
print control means for converting the contents selected by said selecting means into print-data and outputting said print data to printing means; and
print maintenance means for changing said print permission/inhibition information,
wherein said print maintenance means changes said print permission/inhibition information in accordance with command information.

2. An apparatus according to claim 1, wherein said command information is transmitted together with a broadcasted event included in said digital broadcast wave and said print maintenance means makes control based on said command information in accordance with execution of said broadcasted event.

3. An apparatus according to claim 1, wherein said data broadcasting data includes charge information set in each of said contents and said display control means sums the charge information of the contents selected by said selecting means and displays the sum.

4. A data broadcasting print service system which includes a data broadcasting apparatus for previously adding an attribute to each contents of data comprising a plurality of contents such as video images, audio sound, characters, images, and the like, thereafter, multiplexing the resultant contents to a broadcasting wave, and transmitting the multiplexed contents and in which the broadcasting data is received, stored, reproduced, and displayed by a data broadcasting receiving and reproducing apparatus of the viewer and the data is transferred to a printing apparatus and print-outputted,
wherein said data broadcasting receiving and reproducing apparatus further has a function for determining whether said broadcasting data is transferred to said printing apparatus or not in accordance with the attribute added to each contents of said broadcasting data, and
print permission/inhibition information of each of said contents is changed in accordance with a broadcasted event.

5. A reproducing method comprising the steps of:
receiving a digital broadcasting wave;
obtaining data broadcasting data for displaying a plurality of contents from said received digital broadcasting wave;
controlling display means so as to display said plurality of contents; and
converting specific contents selected on the basis of print permission/inhibition information showing permission or inhibition of printing of each of said plurality of contents into print data,
wherein said print permission/inhibition information is changed in accordance with received command information.

6. A method according to claim 5, wherein a page description language to display said plurality of contents includes a script for changing said print permission/inhibition information in response to said command information.

7. An apparatus according to claim 1, wherein said command information is transmitted in a broadcast wave.

8. A method according to claim 5, wherein said command information is transmitted in a broadcast wave.
